(19) United States
(12) Patent Application Publication
(10) Pub. No.: US 2006/0082195 A1
(43) Pub. Date: Apr. 20, 2006

(54) Personnel-supporting apparatus

(75) Inventor: Merwin Jiang, Tai Ping City (TW)

Correspondence Address: NIKOLAI & MERSEREAU, P.A., 900 SECOND AVENUE SOUTH, SUITE 820, MINNEAPOLIS, MN, 55402, US

(73) Assignee: Home Health Technology Co., Ltd., Daili City (TW)

(21) Appl. No.: 10/967,583

(22) Filed: Oct. 18, 2004

(51) Int. Cl. A61G 15/00

(52) U.S. Cl. 297/68

(57) ABSTRACT

A personnel-supporting apparatus includes a base. At least one rocker is installed on the base. A backrest is connected with the rocker. At least one rod includes a first end connected with the rocker and a second end. A stool device is pivotally connected with the second end of the rod and pivotally connected with the base. A toggle extends from the stool device. A link is pivotally connected with the toggle. A seat frame is pivotally connected with the link and movably installed on the base. A linear actuator includes a first end connected with the base and a second end connected with the second end of the rod. As the linear actuator is extended, the backrest is lowered, the stool device is lifted and the seat frame is moved towards the backrest. As the linear actuator is shrunk, the backrest is lifted, the stool device is lowered and the seat frame is moved towards the stool device.

### BACKGROUND OF INVENTION

1. Field of Invention

The present invention relates to a personnel-supporting apparatus.

2. Related Prior Art

Referring to FIG. 11, a conventional wheelchair includes a chassis 100, two rear wheels 102 attached to the chassis 100, two front wheels 104 attached to the chassis 100, two telescopic elements 106 pivotally connected with the chassis 100, two stools 108 each attached to one telescopic element 106, two seat frames 110 pivotally connected with the chassis 100 for supporting a seat, two backrest frames 112 each pivotally connected with one seat frame 110 for supporting a backrest, and two armrests 114 each pivotally connected with one backrest frame 112. A user who is crippled, wounded or sick can sit on or lie in the wheelchair. To sit, the user has the telescopic elements 106 in a vertical position and the backrest frames 112 in a vertical position too. To lie, the user has the telescopic elements 106 in a horizontal position and the backrest frames 112 in a horizontal position. However, the user feels stress in his or her knees when the telescopic elements 106 are pivoted from the vertical position to the horizontal position. The user may move his or her body in order to reduce the stress in the knees. Yet, it is difficult if not impossible for the user to move the body. Moreover, the user feels stress in his or her spine when the backrest frames 112 are pivoted from the horizontal position to the vertical position. The stress in the spine can further hurt the user.

The present invention is therefore intended to obviate or at least alleviate the problems encountered in prior art.

### SUMMARY OF INVENTION

According to the present invention, a personnel-supporting apparatus includes a base. At least one rocker is installed on the base. A backrest is connected with the rocker. At least one rod includes a first end connected with the rocker and a second end. A stool device is pivotally connected with the second end of the rod and pivotally connected with the base. A toggle extends from the stool device. A link is pivotally connected with the toggle. A seat frame is pivotally connected with the link and movably installed on the base. A linear actuator includes a first end connected with the base and a second end connected with the second end of the rod. As the linear actuator is extended, the backrest is lowered, the stool device is lifted and the seat frame is moved towards the backrest. As the linear actuator is shrunk, the backrest is lifted, the stool device is lowered and the seat frame is moved towards the stool device.

The primary advantage of the personnel-supporting apparatus of the present invention over the conventional wheelchair in Related Prior Art is eliminating the stress in a user's knees and spine.

Other objects, advantages and novel features of the invention will become more apparent from the following detailed description in conjunction with the drawings.

### BRIEF DESCRIPTION OF DRAWINGS

The present invention will be described via detailed illustration of four embodiments referring to the drawings.

FIG. 1 is an exploded view of a wheelchair according to the first embodiment of the present invention.

FIG. 2 is another exploded view of the wheelchair shown in FIG. 1.

FIG. 3 is a perspective view of the wheelchair shown in FIG. 2.

FIG. 4 is a side view of the wheelchair shown in FIG. 3.

FIG. 5 is similar to FIG. 4 but shows a backrest lowered and a footrest lifted.

FIG. 6 is similar to FIG. 5 but shows the backrest fully lowered and the footrest fully lifted.

FIG. 7 is a side view of a wheelchair according to the second embodiment of the present invention.

FIG. 8 is a side view of a chair according to the third embodiment of the present invention.

FIG. 9 is a side view of a bed according to the fourth embodiment of the present invention.

FIG. 10 is similar to FIG. 9 but shows the bed in a different position so that it can be used as chair.

FIG. 11 is a perspective view of a conventional wheelchair.

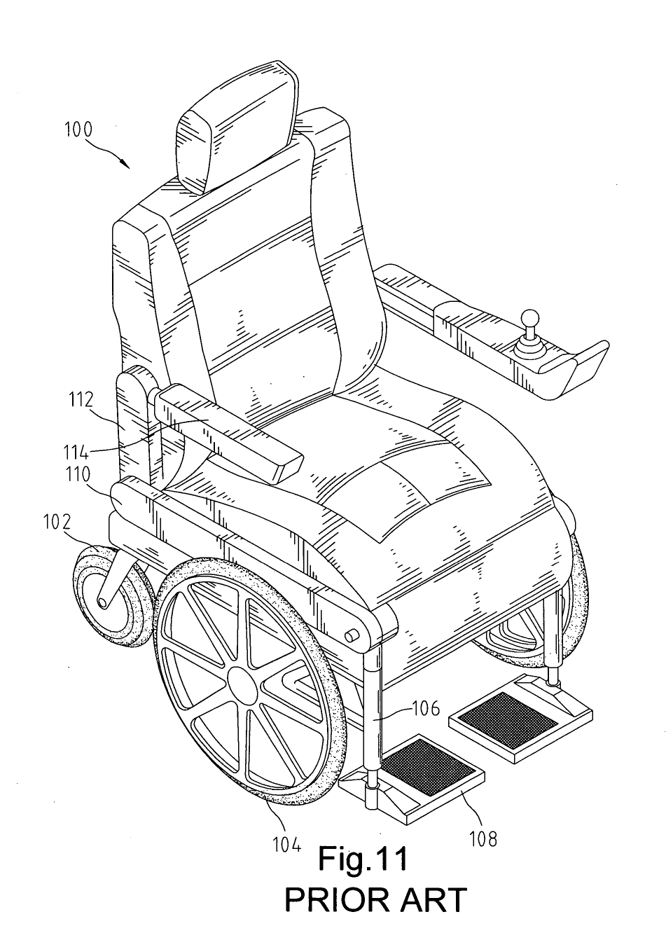

### DETAILED DESCRIPTION OF EMBODIMENTS

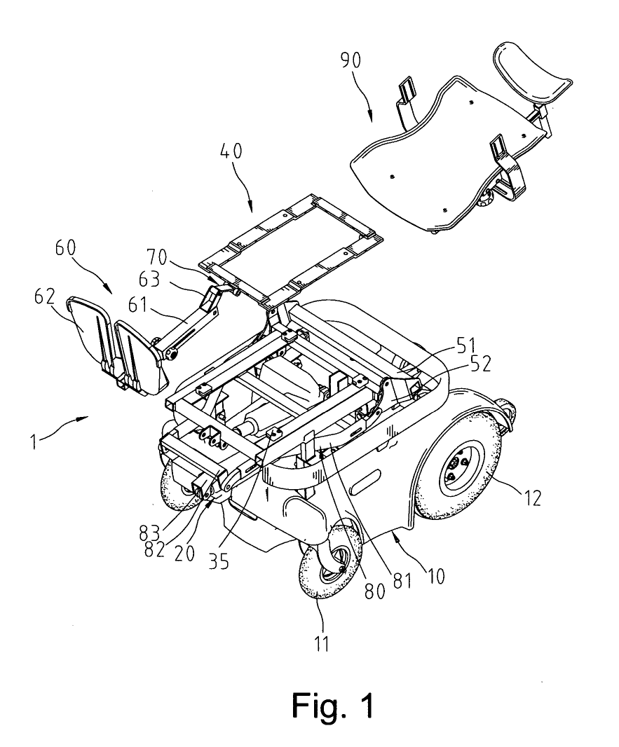

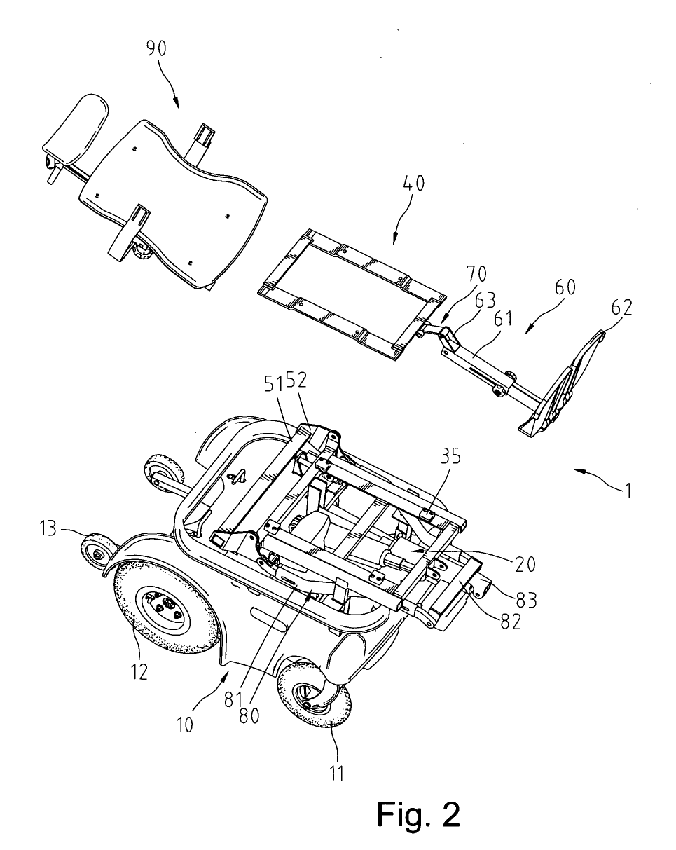

Referring to FIGS. 1 and 2, according to a first embodiment of the present invention, a personnel-supporting apparatus 1 is installed on a cart 10. In other words, the personnel-supporting apparatus 1 and the cart 10 together make a wheelchair.

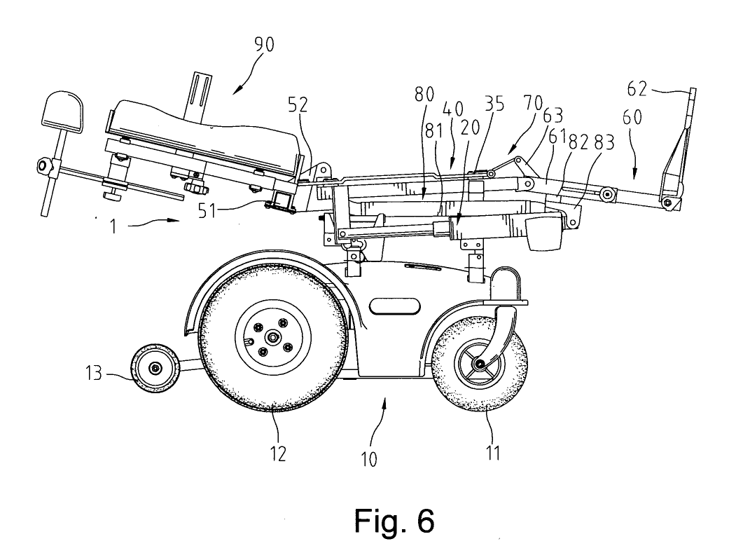

The cart 10 includes two front wheels 11 and two rear wheels 12. The front wheels 11 and the rear wheels 12 will not be described in detail for being conventional. The cart 10 includes two auxiliary wheels 13 located behind the rear wheels 12 in order to prevent tilting of the cart 10 when the personnel-supporting apparatus 1 is in a position for a user to lie in it (FIG. 6).

The personnel-supporting apparatus 1 includes a frame 30, a backrest 90, a linking device 80, a linear actuator 20, a stool device 60, a seat frame 40 and a link 70.

Two rockers 52 are installed on the cart 10. A crossbar 51 extends between the rockers 52.

The backrest 90 is secured to the crossbar 51. Thus, the bracket 90 is pivoted when the rockers 52 are pivoted.

The linking device 80 includes two rods 81, a cross member 82 and a bracket 83. Each rod 81 is pivotally connected with one rocker 52. The cross member 82 extends between the rods 81. The bracket 83 is secured to the cross member 82.

The linear actuator 20 is pivotally connected with the bracket 83 at an end and pivotally connected with the cart 10 at an opposite end. Thus, the extension and shrinkage of the linear actuator 20 cause pivotal of the backrest 90 through the linking device 80 and the rockers 52.

The stool device 60 includes a telescopic element 61, two footrests 62 attached to an end of the telescopic element 61 and a toggle 63 attached to an opposite end of the telescopic element 61. The telescopic element 61 is secured to the cross member 82. Thus, the extension and shrinkage of the linear actuator 20 cause pivotal of the stool device 60 through the brackets 83 and the cross member 81.

The link 70 is pivotally connected with the toggle 63. The seat frame 40 is pivotally connected with the link 70. The seat frame 40 is movably installed on the cart 10 by means of four guides 35. Thus, the extension and shrinkage of the linear actuator 20 cause movement of the seat frame 40.

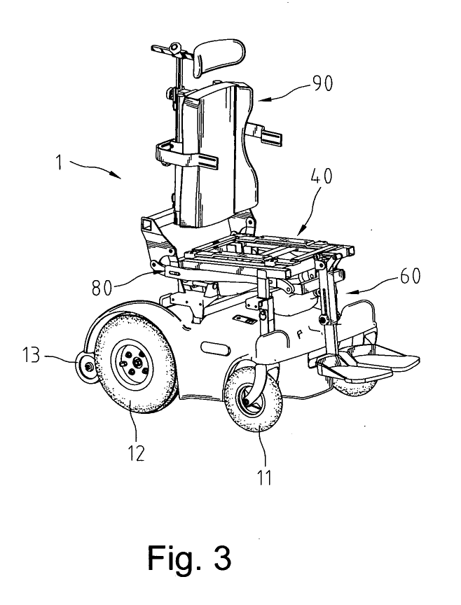

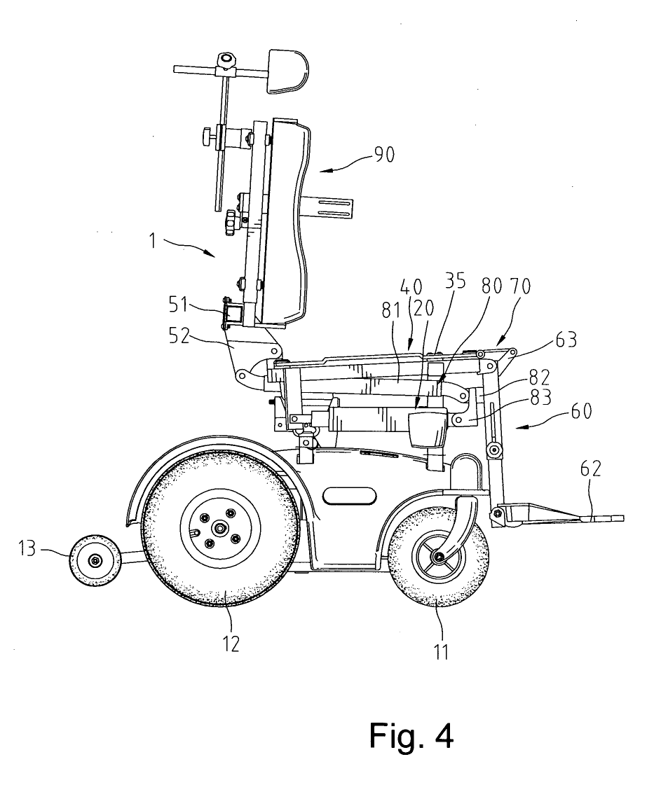

Referring to FIGS. 3 and 4, the backrest 90 is substantially perpendicular to the seat frame 40, and the stool device 60 is also substantially perpendicular to the seat frame 40. Thus, the personnel-supporting apparatus 1 looks and functions like a chair on which the user can sit.

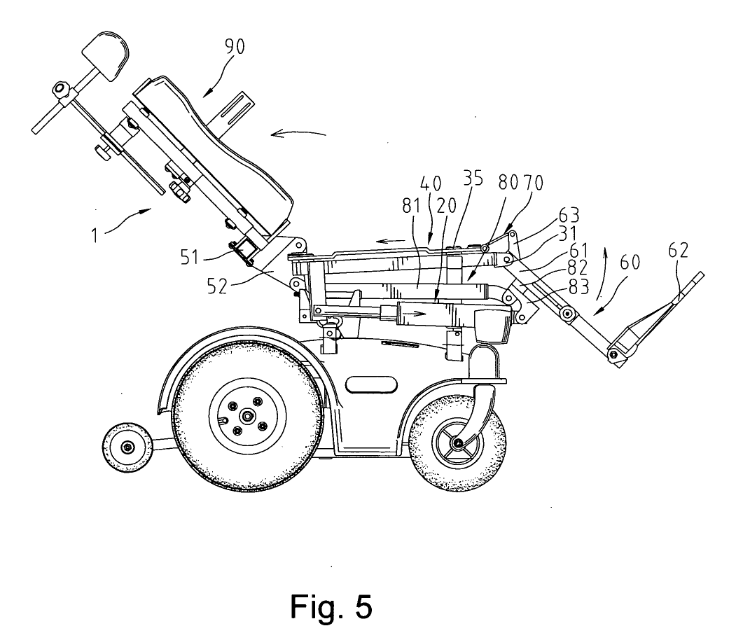

Referring to FIG. 5, the linear actuator 20 is undergoing a process of extension. The cross member 82 is pushed forwards. On one hand, the rods 81 are pulled forwards. The rockers 52 are pivoted backwards. Thus, the backrest 90 is lowered. On the other hand, the telescopic element 61 is pivoted upwards. Thus, the stool device 60 is lifted. At this instant, the toggle 63 is pivoted backwards. The link 70 is pushed backwards. Thus, the seat frame 40 is pushed backwards. Therefore, there is no stress in the knees of the user.

Referring to FIG. 6, the linear actuator 20 is fully extended. The backrest 90 is at a small angle from the seat frame 40, and the stool device 60 is also at a small angle from the seat frame 40. Thus, the personnel-supporting apparatus 1 looks and functions like a bed in which the user can lie.

When the linear actuator 20 is moved to the shrunk position from the fully extended position, the cross member 82 is pulled backwards. On one hand, the rods 81 are pushed backwards. The rockers 52 are pivoted forwards. Thus, the backrest 90 is lifted. On the other hand, the telescopic element 61 is pivoted downwards. Thus, the stool device 60 is lowered. At this instant, the toggle 63 is pivoted forwards. The link 70 is pulled forwards. Thus, the seat frame 40 is pulled forwards. Therefore, there is no stress in the spine and knees of the user.

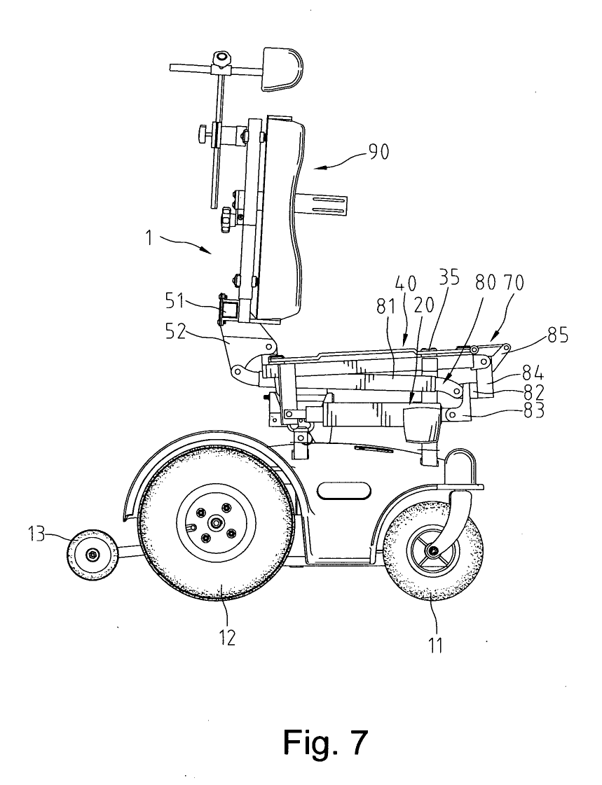

FIG. 7 shows a personnel-supporting apparatus 1 according to a second embodiment of the present invention. The second embodiment is identical to the first embodiment except for saving the stool device 60 and for including a rod 84 and a toggle 85 instead of the telescopic element 61 and the toggle 63, respectively. As the linear actuator 20 is moved to the shrunk position from the fully extended position, the cross member 82 is pulled backwards. On one hand, the rods 81 are pushed backwards. The rockers 52 are pivoted forwards. Thus, the backrest 90 is lifted. On the other hand, the rod 84 is pivoted downwards. The toggle 85 is pivoted forwards. The link 70 is pulled forwards. Thus, the seat frame 40 is pulled forwards. Hence, there is no stress in the spine of the user.

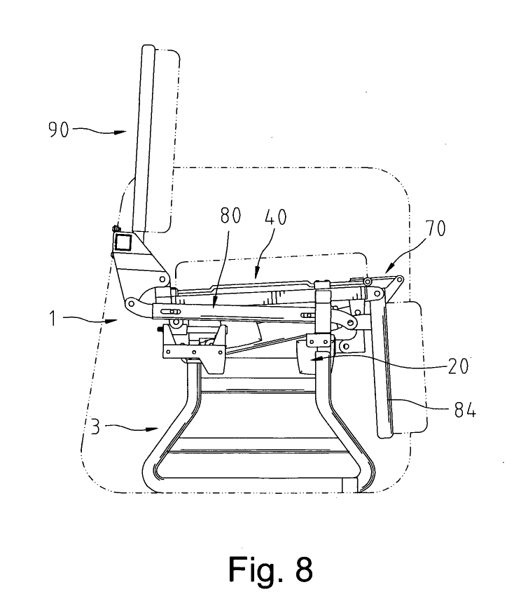

FIG. 8 shows a personnel-supporting apparatus 1 according to a third embodiment of the present invention. The third embodiment is identical to the first embodiment except for installment on a base 3 instead of the cart 10. Thus, the personnel-supporting apparatus 1 looks and functions like a sofa and, more particularly, like a recliner.

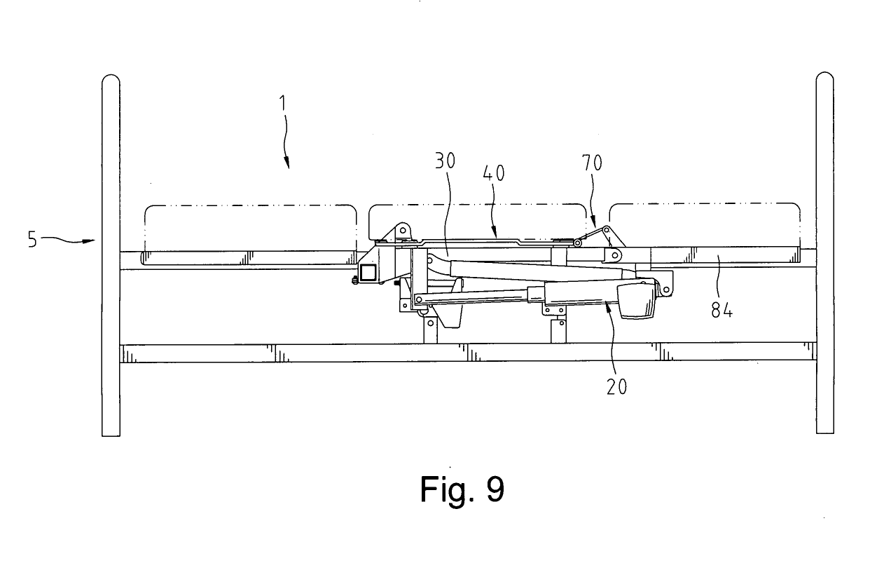

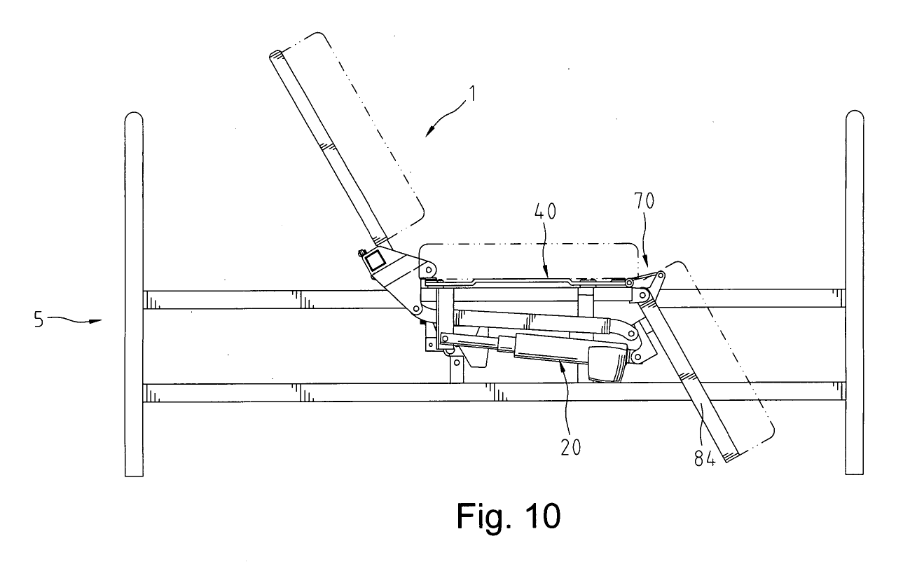

FIGS. 9 and 10 show a personnel-supporting apparatus 1 according to a fourth embodiment of the present invention. The fourth embodiment is identical to the second embodiment except for installment on a base 5 instead of the cart 10. Thus, the personnel-supporting apparatus 1 looks and functions like a bed particularly useful in a hospital.

Although not shown, the personnel-supporting apparatus 1 can be embodied as a chair for use in a vehicle and a chair for use in an office.

The present invention has been described via detailed illustration of the embodiments. Those skilled in the art can derive variations from the embodiments without departing from the scope of the present invention. Therefore, the embodiments shall not limit the scope of the present invention defined in the claims.

What is claimed is:

1. A personnel-supporting apparatus comprising a base, at least one rocker installed on the base, a backrest connected with the rocker, at least one rod comprising a first end connected with the rocker and a second end, a stool device pivotally connected with the second end of the rod and pivotally connected with the base, a link pivotally connected with the stool device, a seat frame pivotally connected with the link and movably installed on the base, and a linear actuator comprising a first end connected with the base and a second end connected with the second end of the rod, wherein the backrest is lowered, the stool device is lifted and the seat frame is moved towards the backrest as the linear actuator is extended, wherein the backrest is lifted, the stool device is lowered and the seat frame is moved towards the stool device as the linear actuator is shrunk.

2. The personnel-supporting apparatus according to claim 1 wherein the base is a cart.

3. The personnel-supporting apparatus according to claim 1 wherein the base is in the form of a lower portion of a chair.

4. The personnel-supporting apparatus according to claim 1 wherein the base is in the form of a lower portion of a bed.

5. The personnel-supporting apparatus according to claim 1 comprising two rockers.

6. The personnel-supporting apparatus according to claim 5 comprising a crossbar extending between the rockers.

7. The personnel-supporting apparatus according to claim 6 wherein the backrest is attached to the crossbar.

8. The personnel-supporting apparatus according to claim 5 comprising two rods each pivotally connected with one of the rockers.

9. The personnel-supporting apparatus according to claim 8 comprising a cross member extending between the second ends of the rods.

10. The personnel-supporting apparatus according to claim 9 wherein the second end of the linear actuator is pivotally connected with the cross member.

11. The personnel-supporting apparatus according to claim 9 comprising a bracket attached to the cross member, wherein the second end of the linear actuator is pivotally connected with the bracket.

12. The personnel-supporting apparatus according to claim 1 wherein the stool device comprises a telescopic element, wherein the link is connected with the telescopic element.

13. The personnel-supporting apparatus according to claim 12 wherein the stool device comprises two footrests attached to the telescopic element.

14. The personnel-supporting apparatus according to claim 12 wherein the stool device comprises a toggle extending from the telescopic element, wherein the link is connected with the toggle.

15. The personnel-supporting apparatus according to claim 1 comprising a plurality of guides installed on the base in order to guide the seat frame in movement.
